(19) United States
(12) Patent Application Publication
(10) Pub. No.: US 2024/0071173 A1
(43) Pub. Date: Feb. 29, 2024

(54) CASINO TOKEN COUNTING SYSTEMS, DEVICES, AND METHODS

(71) Applicant: Gary R Boucher, Springhill, LA (US)

(72) Inventor: Gary R Boucher, Springhill, LA (US)

(21) Appl. No.: 18/227,263

(22) Filed: Jul. 27, 2023

Related U.S. Application Data
(60) Provisional application No. 63/373,713, filed on Aug. 27, 2022.
(60) Provisional application No. 63/469,563, filed on May 30, 2023.

(51) Int. Cl. G07F 17/32; G06M 9/00

(52) U.S. Cl. CPC G07F 17/3241; G06M 9/00; G07F 17/3232; G07F 17/3248

(57) ABSTRACT

A microcontroller-based casino token counting system including one or more token bins comprising a casino dealer token tray suitable for receiving and holding stacks of tokens for the purpose of counting the tokens and calculating both quantities for each bin and total monetary values for all tokens in the dealer tray. Detection of token quantity in each bin is accomplished in various embodiments including Contact Image Sensors, Linear Image Sensors, and methods of converting both reflected light from each token, or detection of shadows cast by tokens using ambient casino lighting. Tray data from all bins is thus displayed to the operator, stored, and/or transmitted for the purpose of remote monitoring.

### CROSS-REFERENCE TO RELATED APPLICATIONS

This application claims the benefit of U.S. provisional application No. 63/373,713, filed Aug. 27, 2022, and entitled Counting Device Utilizing Contact Image Sensors for Determination of Quantity and Monetary Value of Casino Tokens, and U.S. provisional application No. 63/469,563, filed May 30, 2023, and entitled CASINO TOKEN COUNTING DEVICE, each of which provisional applications is hereby incorporated by reference herein in its entirety.

### FIELD

Illustrative embodiments of the disclosure generally relate to systems, devices, and methods for monitoring the number of casino tokens in a token bin on a token tray. More particularly, illustrative embodiments of the disclosure relate to systems, devices, and methods which utilize optical techniques to precisely monitor and maintain a running count of casino tokens in a token bin of a token tray.

### BACKGROUND

Various methods have been attempted in efforts to measure the number of casino tokens in a bin such as weighing the tokens to obtain a total count, sensing the height of the token stack using laser triangulation, light and sound time-of-flight distance measurement, or even placing RFID devices in each token. These methods show some utility, but most, if not all, suffer from complexity, inaccuracy, expense, or unreliability. Most of these efforts to measure bin counts fall into one of two categories; individual token measurement, where one sensor per token must be used, or the methods for measuring the distance from the top of the bins to the last stacked token. In this latter set of methods, knowing the space from the top token to the top of the bin allows the token stack height to be calculated with a simple subtraction.

The RFID methods require a new set of tagged tokens to be employed by the casinos. This method also suffers from excitation problems as well as collisions of data as many tokens may transmit at the same time.

One major problem with using a single LED and light sensor per token is that tokens are often of different thicknesses for different casino locations. Also, tokens wear as they age making them thinner. Another problem is that a stack of tokens may compress differently due to surface conditions causing the stack to be shorter or longer for different measurements. To market an electronic token sensing tray using one sensor combination per token requires creating hardware for each casino location. If such sensors are located on a printed circuit board, the board must have different component spacing for each casino using different token thicknesses. This requires a large number of slightly different circuit boards.

The optical method revealed in this invention avoids most if not all the pitfalls of other methods of measurement. In one embodiment, the invention can identify the gaps between individual tokens in a stack. This method becomes almost error-proof. The CIS device used is similar, if not in some cases identical, to those used in flatbed scanners. Linear Image Sensors with much higher than one token width resolution may be employed. The typical CIS sensor uses embedded LEDs and photo detectors to read a single line of relative light intensity return levels from a surface. The spacing between such source-detector combinations can be a few hundredths of a millimeter representing almost two orders of magnitude better resolution than conventional methods. In a flatbed scanner, the CIS device moves across a page reading one line of pixels at a time. In this invention the sensor is stationary below or to the side of the tokens to be sensed. This approach will avoid many of the pitfalls of other methods, yielding greatly improved accuracy at far lower cost.

### SUMMARY

A tray of casino tokens usually contains numerous columns or (bins) of tokens, each with a fixed denomination. To determine the monetary value of each bin one must count the chips in that bin and multiply by the known bin denomination. In doing this for all columns and adding all the bin monetary values, the total monetary value of the tray can be determined. This is extremely useful in maintaining security of tokens and reducing table theft.

A host computer located in or under the token tray is the preferred embodiment and may consist of a simple microcontroller unit (MCU) that issues requests to the bin CIS sensors and records the streamed results as they are transmitted from the CIS devices back to the MCU. Normally only one CIS device will be queried at a given time until the data is returned, before the next bin is read. Multiple CIS devices can be read simultaneously if more speed is desired. Once all bins are read and recorded, the process starts over and continues in a cyclic manner. The data can be displayed in any one of the numerous opto-electronic methods available in the current art such as LED or liquid crystal displays. The data can also be transmitted via wired or wireless means to remote locations in the casino or elsewhere if monitoring of the table is needed remotely.

In the preferred embodiment of this invention a Contact Image Sensor (CIS) is used. This device is nearly, if not completely identical to those used in flatbed scanners and copiers. Optimally, the CIS device has a sensing length equal to or greater than the maximum height of the token bin. However, more than one CIS device may be employed in each bin to read the full length of the token stack. Having CIS sensors that are operated in parallel can be used to increase accuracy as the results are compared in the MCU or host computer. In this way a marginal read may be more defined if redundant reads can be compared via algorithms used by the MCU. If more than one CIS sensor is required to read the full height of the token stack, two CIS sensors may be overlapped for a small distance to assure continuity.

Normally, the MCU sends a read command and waits for the returning stream of pixilated data or analog levels. Various algorithms utilized to interpret the data can be easily developed by anyone skilled in the art. The simplest embodiment of this invention examines the returning data and determines the pixels representing a token light return before reading pixel data that represents no tokens. The distance between the first pixel identifying a token and the first pixel reading no token represents the length of the token stack in pixel widths. By dividing this stack length in pixels by the average thickness of the token in pixel widths the number of tokens in the stack can be calculated.

In the preferred embodiment of the invention, the returning data is searched for small lower light return regions representing the small gap regions between each well-stacked token. This effect can be enhanced by the slight rounding of most token edges creating a wider stacking gap near their outer edge. Counting these narrow gaps allows the MCU to determine the number of gaps for each bin and in turn the number of tokens in the bin. If no gaps are located, this condition may represent no tokens at all being read.

Algorithms can also be employed by the MCU to look for larger gaps where little or no returned light for some larger number of pixels is present followed by more token-identifying pixel returns. This can represent an improperly stacked bin of tokens. Large gaps in the token stack are undesirable and should never be counted as tokens. This is a serious problem with most counting methods, but can easily be handled with the proper programming of the MCU, which is well within the ability of skilled computer programmers. The reading algorithm simply ignores the larger gaps as non-token space if the gap counting method is used and can be reported as a stacking error if the stack height counting method is used. In some embodiments, the MCU may be configured to recognize at least one gap exceeding a selected size between adjacent ones of the casino tokens in the token stack as improper stacking of the casino tokens in the token stack.

### BRIEF DESCRIPTION OF THE DRAWINGS

Illustrative embodiments of the disclosure will now be described, by way of example, with reference to the accompanying drawings, in which:

FIG. 1 is a functional block diagram of an illustrative embodiment of the casino token counting systems;

FIG. 2 is a top view of a typical token tray of the casino token counting system illustrated in FIG. 1;

FIG. 3A is an enlarged cross-sectional view of a token bin in the token tray illustrated in FIG. 2, with a bin slot in the bottom of the token bin, a token sensor adjacent to the bin slot, and a casino token in the token bin above the bin slot in typical application of the casino token counting system;

FIG. 3B is a cross-sectional view of a typical contact image sensor suitable for use as the token sensor illustrated in FIG. 3A, with a sensor housing containing the various components of the sensor and incident light beams emitted by light sources against a casino token in the token bin, reflected light beams from the casino token passing through a rod lens, and a converging light beam emerging from the rod lens onto a light sensor in the sensor housing in typical application of the casino token counting system;

FIG. 3C is an enlarged sectional view of a portion of the token tray with the bin slot extending the length of the token bin and a single token sensor (illustrated in phantom) traversing the length of the token bin adjacent to the bin slot according to some embodiments of the casino token counting systems;

FIG. 3D is an enlarged sectional view of a portion of the token tray with a pair of bin slots extending the length of the token bin and a pair of parallel token sensors (illustrated in phantom) traversing the length of the token bin adjacent to the respective bin slots according to some embodiments of the casino token counting systems;

FIG. 5 is a cross-sectional view illustrating a token bin of a token tray in typical use of linear image sensors as the token sensor according to an alternative embodiment of the casino token counting systems;

FIG. 6 is a side view of the token tray with the token bin and linear image sensors illustrated in FIG. 5;

FIG. 7 is a cross-sectional view illustrating a token bin of a token tray in typical use of linear image sensors as the token sensor with ambient casino lighting as a light source according to another alternative embodiment of the casino token counting systems; and

FIG. 8 is a side view of the token tray with the token bin and linear image sensors illustrated in FIG. 7.

### DETAILED DESCRIPTION

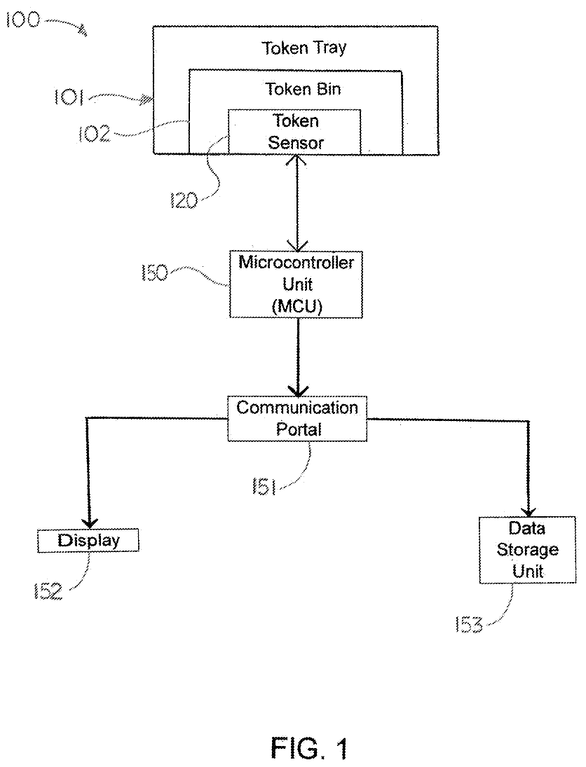

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “aft”, “right”, “fore”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless expressly or implicitly indicated otherwise, throughout the description and the appended claims, the terms “comprise”, “comprising”, “comprised of”, “having”, “including”, and the like are to be construed in an inclusive sense as opposed to an exclusive or exhaustive sense, and are equivalent to the phrase, “including but not limited to”. Each embodiment disclosed herein can comprise, consist essentially of, or consist of its particular stated element, step, ingredient, or limitation. As used herein, the transition term “comprise” or “comprises” means “includes, but is not limited to, and allows for the inclusion of unspecified elements, steps, ingredients, or limitations, even in major amounts”. The transitional phrase “consisting of” excludes any element, step, ingredient, or limitation not specified. The transition phrase “consisting essentially of” shall limit the scope of the embodiment to the specified elements, steps, ingredients, or limitations and to those that do not materially affect the embodiment.

Unless otherwise noted using precise or limiting terminology, all numbers which express quantities of ingredients throughout the specification and claims are to be understood as being approximations of the numerical value cited to express the quantities of those ingredients. As used throughout the specification and claims, the terms “about” and “generally” have the meaning reasonably ascribed to those terms by a person skilled in the art when used in conjunction with a stated numerical value or range, i.e., denoting from the exact stated value or range to somewhat more or somewhat less than the stated value or range, from a deviation of from 0% with respect to the stated value or range to up to and including 15% of the stated value or range in either direction.

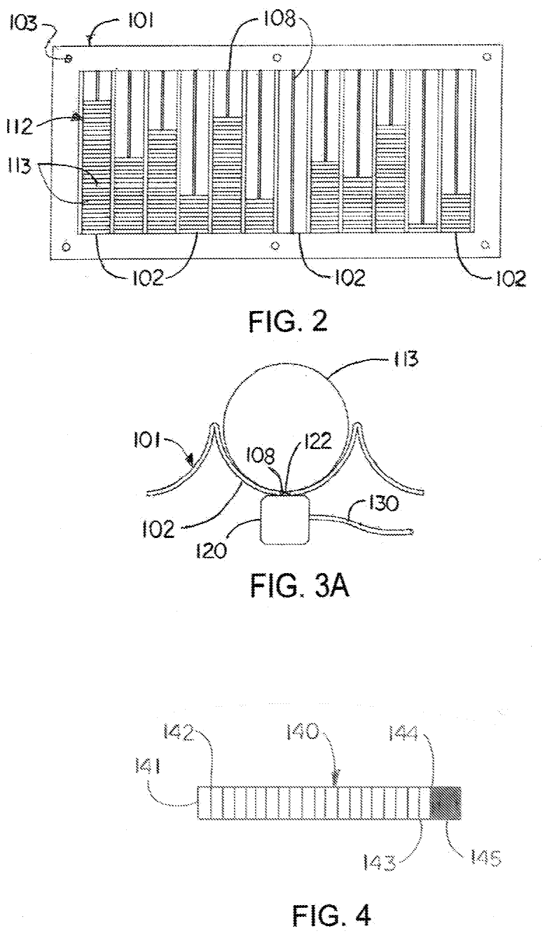

Referring initially to FIGS. 1-4 of the drawings, an illustrative embodiment of the casino token counting system, hereinafter system, is generally indicated by reference numeral 100 in FIG. 1. As will be hereinafter described, the system 100 may be configured to utilize optical techniques to precisely monitor and maintain a running count of casino tokens 113 (FIG. 2) in at least one token bin 102 of at least one token tray 101. At least one token sensor 120 may be deployed at each token bin 102 to optically monitor the number of casino tokens 113 in each token bin 102, typically as will be hereinafter described. At least one microcontroller unit (MCU) 150 may communicably interface with the token sensor 120 at each token bin 102 in the token tray 101. At least one display 152 may communicably interface with the MCU 150 typically through a communication portal 151. The display 152 may be configured to numerically, graphically, and/or otherwise indicate the number of casino tokens 113 in each token bin 102 of each token tray 101 according to the knowledge of those skilled in the art. At least one data storage unit 153 may communicably interface with the MCU 150 typically via the communication portal 151. The data storage unit 153 may have the capacity to store, retrieve and present or transfer data which relates to monitoring of the number of casino tokens 113 in each token bin 102 of each token tray 101 over selected time periods. The communication portal 151 may include at least one wired and/or at least one wireless interface.

FIG. 2 represents an overhead view of an illustrative token tray 101 which is suitable for implementation of the system 100. The token tray 101 may include mounting apertures 103 to facilitate anchoring of the token tray 101 to a casino table (not illustrated) typically with screws, bolts and/or other mechanical fasteners (not illustrated). A token stack 112 of casino tokens 113 is shown partially filling the first (left-most) token bin 102 in the token tray 101. Bin slots 108 in the token tray 101 allow the token sensors 120 to be exposed to the casino tokens 113. A vacant token bin 102 in the middle of the token tray 101 shows the full length of the bin slot 108, which may be coextensive with the length of the token bin 102. The last token bin 102 in the token tray 101 is located on the far right of the token tray 101 in FIG. 2.

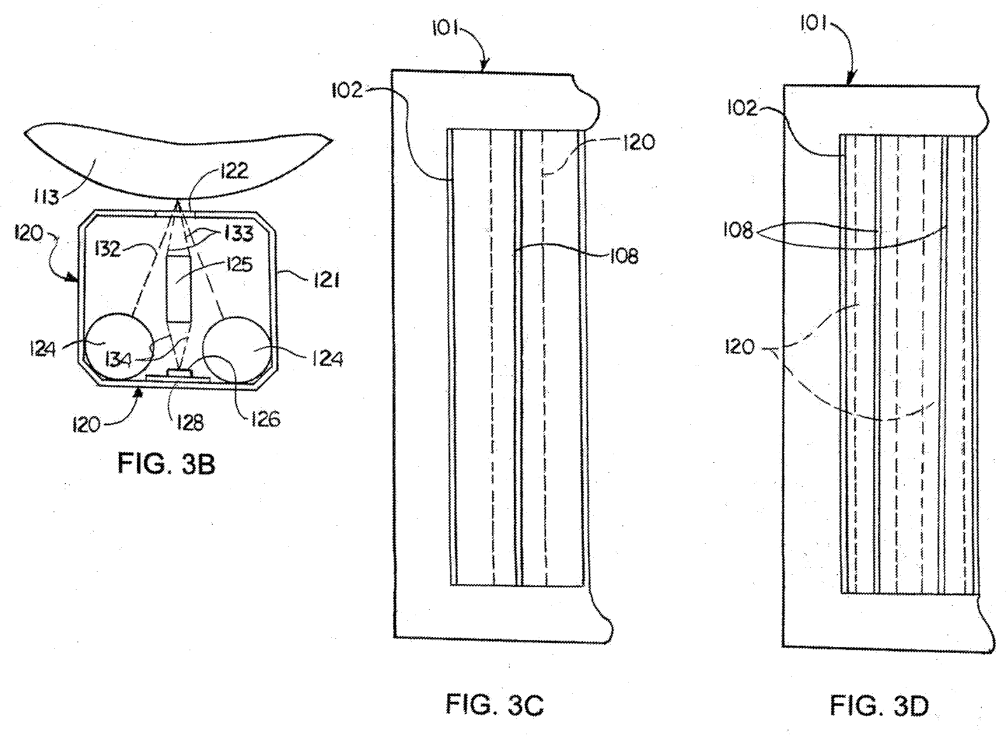

FIG. 3A shows how a casino token 113 rests in a token bin 102 in the center of the token bin 102 through gravity. Token bins 102 can use a slight elevation on the top (opposite side from dealer) to allow for proper stacking of the casino tokens 113 therein. Under the token bin 102 is the corresponding bin slot 108. A CIS sensor window 122 is shown placed so that it will be in direct contact or near the bottom of the casino token 113. The complete CIS token sensor 120 is shown below the bin slot 108 with connective wiring 130 connecting the CIS token sensor 120 to the MCU 150 (FIG. 1) in some embodiments.

FIG. 3B is a cross-sectional view of a typical contact image sensor (CIS) which is suitable for use as the token sensor 120 illustrated in FIG. 3A. In some embodiments, the CIS token sensor 120 may include a sensor housing 121 which contains the various components of the token sensor 120. At least one light source 124 may be provided in the sensor housing 121. In some embodiments, the light source 124 may include one or more LEDs. An array of converging lenses 125, which may be a rod lens array, may be provided in the sensor housing 121 along the length of the token sensor 120. The light source(s) 124 may be oriented to emit incident light beams 132 from the sensor housing 121 through the sensor window 122 and against a casino token 113 in the token bin 102. Reflected light beams 133 from the casino token 113 may pass back through the sensor window 122 and then through a rod lens 125 in the sensor housing 121. A converging light beam 134 may emerge from the rod lens 125 and impinge onto a photosensor 126 which is provided typically in the bottom of the sensor housing 121. An ASIC (Application-Specific Integrated Circuit) 128 may functionally interface with the photosensor 126. The ASIC 128 may interface with the MCU 150 (FIG. 1) such as via the connective wiring 130 (FIG. 3A).

FIG. 3C is an enlarged sectional view of a portion of the token tray 101 according to some embodiments of the system 100. In the token tray 101, each bin slot 108 may extend substantially the entire length of its corresponding token bin 102. A single token sensor 120 (illustrated in phantom) may traverse the length of the token bin 102 adjacent to the bin slot 108. As used herein, the phrase, “adjacent to the bin slot 108” includes but is not limited to the phrase, “beneath and/or to one or more sides of the bin slot 108”.

FIG. 3D is an enlarged sectional view of a portion of the token tray 101 according to some embodiments of the system 100. A pair of bin slots 108 of the token tray 101 may extend substantially the length of the token bin 102 in parallel, spaced-apart relationship to each other. A pair of token sensors 120 (illustrated in phantom) may traverse the length of the token bin 102 adjacent to or beneath each corresponding bin slot 108 in parallel relationship to each other. The parallel token sensors 120 may be thus configured to obtain redundancy of data for better algorithmic processing of the height of the token stack 112.

FIG. 4 is a cropped JPG image 140 from a desktop scanner using a typical CIS sensor normally used to scan documents and photographs. This scanned image represents a vertical slice of a stack of casino tokens 113. The left-most edge 141 of the image 140 represents the bottom of the first casino token 113 in the token stack 112. A first gap 142 between the first and second casino tokens 113 is clearly seen as a dark line. The last gap 143 is seen as the bottom of the top casino token 113 in the token stack 112 with a dark region 145 indicating no casino tokens present. This region of no casino tokens present starts at the top of the last casino token 144 and extends to the top of the token bin 102. In some embodiments, a gap which exceeds a selected size between adjacent casino tokens 113 in the token stack 112 may indicate improper stacking of the casino tokens 113 in the token stack 112.

As illustrated in FIGS. 2-4, in some embodiments, the system 100 may utilize token sensors 120 which may be Contact Image Sensors (CIS) having both LEDs as the light source 124 and photodetectors as the photosensor or photosensors 126 nearly collocated to both illuminate a token stack 112 in each token bin 102 of the token tray 101 and detect the presence of returned light 133, 134 (FIG. 3B) reflected from the casino tokens 113 in the token stack 112. The incident light beams 132 emitted by the light sources 124 may be white, colored, or infrared light. Ultraviolet light can be used if the casino tokens 113 are designed to re-emit certain wavelengths of light in response to UV illumination. Such methods can be used to identify various token information or denominations (token data) without reference to the visible color of the casino token 113 under ambient light. In some embodiments, this token identification method can be achieved by treating casino tokens 113 with various fluorescent materials or dyes. This method can also be used for the detection of counterfeit casino tokens 113.

CIS sensors can detect light returned from single small points on a token surface along its thickness axis, one pixel at a time. When this type of sensor is used in a flatbed scanner or copier, one complete line of pixels is read before the sensor moves to a new location for sensing an adjacent line of pixels. A document or other object is thus read one line of pixels at a time with the values of each transmitted from the CIS sensor, usually in a serial manner to a host computer or microcontroller unit (MCU).

In implementation of the system 100, the CIS token sensor 120 does not move as it would in a flatbed scanner but simply rests in contact with or near the token stack 112 of casino tokens 113 in a particular token bin 102 of the token tray 101. A 12-column token tray 101 would thus have 12 separate CIS token sensors 120, one for each token bin 102. These token sensors 120 may communicably interface with the MCU 150 (FIG. 1) where the data can be read in a repeated manner in which the MCU 150 is updated with totals for all casino tokens 113.

In some embodiments, each token bin 102 in the token tray 101 may be read one pixel width at a time, or in consecutive units of measurement each corresponding to one pixel. Thus, if the pixel resolution of the CIS token sensor 120 is 600 pixels per inch and a full column or token stack 112 of casino tokens 113 is 8 inches, there are 4,800 pixel widths in a full token stack 112. This large number of discrete measurable distances will yield far greater resolution in reading over the standard or conventional single LED-single photodetector per token methods.

Several different methods of reading the casino tokens 113 in each token stack 112 can be employed in implementation of the system 100. A direct method may simply read the token stack 112 one pixel width at a time until no returned light is detected by the CIS token sensor 120. In this method the sensor may read past points of zero light returned to get the last token-indicating pixel returning light. This eliminates the pixel counting procedure terminating prematurely due to reading an inter-token gap as the end of the token stack. The token stack 112 may also be read top down looking for the top edge of the top token via light returned. At that point, the total number of pixels which returned light would be divided by the average number of pixels in a token thickness and recorded. This average number of pixels in a token thickness need not be an integer. Since different casinos or different tables in a casino may have slightly different thicknesses of casino tokens 113, the MCU 150 could easily be programmed with the average thickness of the casino tokens 113 in pixel widths, thus making such adjustments as easy as reprogramming a width constant. The MCU 150 may be configured to accommodate various thicknesses in the casino tokens 113 for different casino tables or casinos by changing a recorded value of the average thickness of the casino tokens 113 in pixel widths. The MCU 150 may be configured to store the recorded value of an average thickness of the casino tokens 113 in pixel widths or the recorded value may be stored in the data storage unit 153 (FIG. 1). The MCU 150 may be configured to calibrate or recalibrate the recorded value by measuring a set number of the casino tokens 113 and dividing a pixel height of the token stack 112 by the set number of the casino tokens 113.

In some embodiments, the system 100 may utilize a stack height counting method of determining the number of casino tokens 113 in the token stack 112 of each token bin 102 in each token tray 101. The stack height counting method may require an accurate value for the average thickness of casino tokens 113 in pixel widths. Although this average value can be programmed and changed later in the MCU 150, it can also be determined by using the token tray 102 itself. By stacking a specific number of casino tokens 113 in a token bin 102 or by using a machined calibration cylinder with an N-number token length to form a simulated token stack 112, a calibration can be performed. The height of the token stack 112 in the token bin 102 or the cylinder can be determined in pixel widths. By dividing this total pixel height of the token stack 112 by the representative number of casino tokens 113 in the token stack 112, a floating-point value for each casino token's thickness in pixel widths can be calculated and automatically entered into the MCU 150 EPROM (Erasable Programmable Read-Only Memory. The MCU 150 may be configured to multiply a detected number of the casino tokens 113 in each token bin 102 by a pre-stored monetary value of the casino tokens 113 for the token bin 102 and add and report a total monetary value of each token bin 102 in each token tray 101.

In some embodiments, the system 100 may utilize a gap counting method of reading the casino tokens 113 in each token bin 102 to detect and evaluate the token edges that form small gaps between properly stacked casino tokens 113 in a token stack 112. In this method, the CIS token sensor 120 would be tasked with counting the token gaps between the casino tokens 113 in the token stack 112 rather than the height of the token stack 112. A poorly stacked token stack 112 would show an extended gap which could be ignored by the MCU 150, only to begin counting on the next casino token 113 detected. Algorithms for such detection can be developed by anyone adequately skilled in programming. Artificial intelligence and pattern recognition can be employed to lower the possibility of error to almost zero. Should the reading process detect the absence of a casino token 113 and later continue reading the presence of casino tokens 113, an error condition can be set by notifying the table dealer that the casino tokens 113 need to be stacked properly. In some embodiments, the MCU 150 may be configured to recognize at least one gap which exceeds a selected size or pixel width between adjacent ones of the casino tokens 113 in the token stack 112 as improper stacking of the casino tokens 113 in the token stack 112. The MCU 150 may be configured to generate a fault or error upon recognizing the gap which exceeds the selected size between the adjacent casino tokens 113 and indicate the fault or error on the display 152 (FIG. 1) and/or in some other suitable manner.

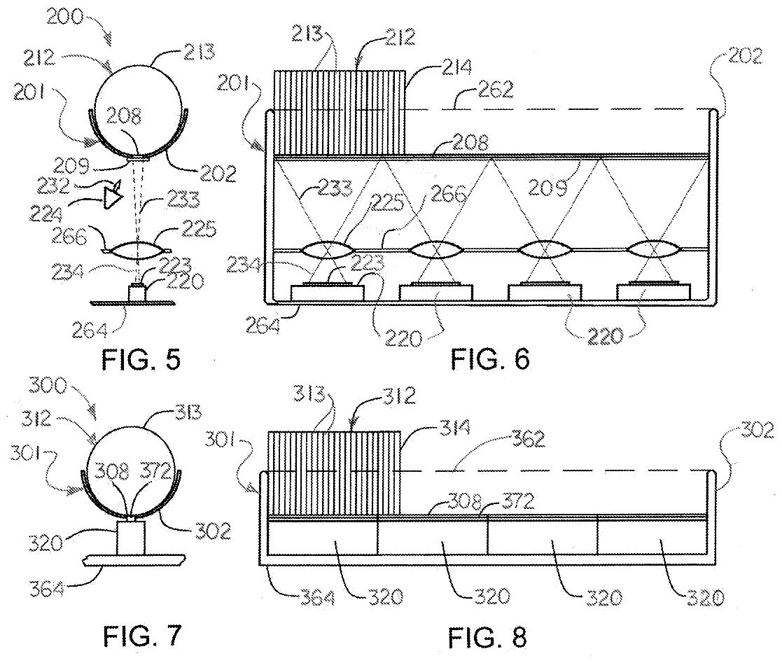

Referring next to FIGS. 5 and 6 of the drawings, an alternative illustrative embodiment of the casino token counting systems is generally indicated by reference numeral 200. Unless otherwise indicated, in the counting system 200, elements which are analogous to the respective elements of the counting system 100 that was heretofore described with respect to FIGS. 1-4 are designated by the same respective numerals in the 200-299 series in FIGS. 5 and 6. FIG. 5 represents a single token bin 202 viewed longitudinally down a token stack 212 of casino tokens 213. A bin slot 208 in the bottom of the token bin 202 and running substantially the entire length of the token bin 202 can utilize a transparent bin slot window 209 to prevent debris from the token tray 201 from inadvertently entering the optics which may include a token sensor 220, a light source 224 and a converging lens 225. The light source 224 directs an incident light beam 232 to illuminate the casino tokens 213 in the token stack 212 through the bin slot window 209 and the bin slot 208. The converging lens 225 may be mounted on a lens support 226. The converging lens 225 may have a focal length capable of converging a reflected light beam 233 from the token stack 212 and emitting the emerging converging light beam 234 onto a sensor surface 223 of the token sensor 220. Accordingly, the linear image token sensor 220 senses the image of the casino tokens 213 in the token stack 212.

FIG. 6 shows a cross section of the token bin 202 illustrated in FIG. 5 and the token stack 212 of the casino tokens 213 with the top casino token 214 in the token stack 212. The bin top edge 262 of the token bin 202 is shown below the top of the token stack 212 and above the bin slot 208. The bin slot 208 and the bin slot window 209 may run substantially the entire length of the token bin 202, thereby allowing incident light 232 furnished from below the bin slot 208 from the light source 224, shown in FIG. 5, to illuminate the casino tokens 213 from below. The reflected light beams 233 reflected from the token stack 212 may pass through the converging lens 225 supported by the lens support 266 to strike the sensor surface 223 of the token sensor 220. In some embodiments, the linear image token sensor 220 may be mounted on a base plate 264.

The system 200 may utilize linear image token sensors 220 (LIS) and a focusing method to focus an image of a section of the token stack 212 onto the token sensor 220 via the converging lenses 225. A linear image sensor is a solid-state device which converts an optical image into an analog signal in a line-by-line fashion. There are two types of linear image sensors with distinct circuit configurations: CMOS image sensors and CCD image sensors. The linear image token sensors 220 may employ CCD or CMOS methods of light sensing and, unlike the CIS casino sensors 120 of the system 100, may not have their own light source. LIS sensors normally return analog levels which must be converted to digital data by an analog to digital converter, which in some embodiments can be a component of the MCU 150 (FIG. 1). Rather than providing the token sensor 220 directly in contact with the casino tokens 213 in the token stack 212, the token sensor 220 may reside a short distance away, in the order of a few centimeters from the bin slot 208 in the token bin 202, preferably covered with the glass sensor window 209 to prevent debris from entering the sensor area. The converging lenses 225 can focus the image of the exposed casino tokens 213 in the token stack 212 onto the plane of the token sensor 220. In this manner, a one-pixel wide image of the casino tokens 213 in the token bin 202 may be created. Light sources 224 such as LEDs may illuminate the casino tokens 213 in each corresponding token stack 212 through the bin slot 208 in the token bin 202, thus providing the converging light beam 234 to be reflected back to the token sensor 220. LIS token sensors 220 which are wider than one pixel width can be employed, and their returns averaged or processed in various ways to obtain a more representative evaluation of a given pixel position.

In the system 200, a plurality of such LIS token sensors 220, paired with respective converging lenses 225, may be required to cover a token stack 212 on the order of several hundred millimeters or more. Information from the token sensor 220 may be fed to the MPU 150 (FIG. 1) for digital conversion, collection, and digital splicing of the multiple images into one continuous collection (strip) of data. Once this is accomplished, the result may be almost identical to the CIS method using the system 100 which was heretofore described with respect to FIGS. 1-4. The token sensors 220 used in the system 200 can be read much like a shift register one pixel at a time. Although the object size (aperture width) of the bin slot 208 may be a few millimeters, only a sample line of pixels with be evaluated in most cases, preferably from the center of the bin slot 208.

In this approach, if 4 linear image token sensors 220 were required for each token bin 202, as illustrated in FIG. 6, and there are 12 token bins 202 in each token tray 201, then a total of 48 token sensors 220 must be read to scan the entire token tray 201. Although it may be preferable to locate the bin slot 208 at the bottom of each token bin 202, other positions for the bin slot 208, such as on the sides of the token bin 202, for example and without limitation, could also be utilized in various embodiments. In some applications, spherical aberration and other lens issues may be experienced, thus requiring a greater distance between each lens 225 and its corresponding bin slot 208.

Referring next to FIGS. 7 and 8 of the drawings, another alternative illustrative embodiment of the casino token counting systems is generally indicated by reference numeral 300. Unless otherwise indicated, in the counting system 300, elements which are analogous to the respective elements of the counting system 100 that was heretofore described with respect to FIGS. 1-4 are designated by the same respective numerals in the 300-399 series in FIGS. 7 and 8. FIG. 7 represents a single token bin 302 viewed longitudinally down a token stack 312 of casino tokens 313. A bin slot 308 typically in the bottom of each token bin 302 may run substantially the entire length of the token bin 302. A linear image token sensor 320 with a sensor strip 372 shown as having the same length as the token sensor 320 may face upwardly just beneath or to one or more sides (adjacent to) the token stack 312 in the token bin 302. In some embodiments, a base plate 364 may support the token sensor 320.

FIG. 8 shows a cross section of the token bin 302 of the token tray 301 illustrated in FIG. 7, showing the token stack 312 of casino tokens 313 with the top casino token 314 in the token stack 312. The bin slot 308 may run substantially the length of the token bin 302 and allows the linear image token sensor 320 to detect light or shadows from the casino tokens 313.

In some embodiments, the system 300 may be configured to utilize another token measurement method which employs the use of a series of Linear Image Sensors (LIS) token sensors 320. In implementation of the system 300, the height of the token stack 312 can be measured by using only the ambient casino lighting to detect the shadow of the token stack 312 as it falls onto the LIS sensor. In this approach LIS token sensors 320 can be placed below the token stack 312 in close proximity to the token stack 312 to determine the location where the shadow sensed pixels transition into light detected pixels. Pixels receiving shadow-levels of light can allow the MCU 150 (FIG. 1) to calculate the height of the token stack 312. Dividing this shadow height by the average pixel width will thus determine the number of casino tokens 313 in the token stack 2=312. Calibration can be performed in a similar manner to using the CIS method which was heretofore described with respect to FIGS. 1-4. Most CIS sensors have no ability to switch their light source off when reading. If a CIS sensor has this ability, it may be used in leu of the LIS token sensor 320.

In some embodiments, the systems may utilize a method of detecting the number of casino tokens in a token stack by observing a certain color or colors of casino tokens using a CIS or LIS token sensor. Casino tokens in an incorrect token bin could easily be identified. Foreign objects other than casino tokens could also be detected using this method. Sensing color would require a CIS or LIS token sensor which is sensitive to color and not just light having monochromatic or infrared wavelengths. The MCU 150 (FIG. 1) may be configured to discriminate among the casino tokens 313 on the basis of token color. The MCU 150 may be further configured to indicate a denomination error if the color of the casino tokens 313 differs from a predetermined denominational color for the casino tokens 313. In some embodiments, the MCU 150 may be configured to modify a computer-maintained monetary denomination of each token bin 302 in the token tray 301 by discriminating among the casino tokens 313 on the basis of token color. The MCU 150 may be configured to signal mis-stacking of the casino tokens 313 in the token bin 302 by discriminating among the casino tokens 313 on the basis of token color.

Although visible light may be used in all mentioned embodiments, infrared or other wavelengths of light employed by the token sensors may be utilized to be less noticeable and distracting than light in the visible range. Infrared light will usually offer less interference than ambient light in the visible range because less infrared light is present in the typical casino environment.

Reading an entire string of pixel data using a CIS or LIS token sensor is far less complex than attempting to multiplex individual sensors for each casino token. Most CIS and LIS sensors possess serial transmission capabilities that output one pixel at a time until the entire length of the sensor data is reported to the MCU.

Two or more CIS or LIS token sensors may be used on a given column or token stack of casino tokens. This can be arranged to give a longer length for sensing or may be used to achieve redundancy in the reading operation. Token sensors may be placed either at positions along the side or at the bottom of the token stack as determined by whichever location yields more accuracy in the reading process.

Another advantage of the CIS and LIS sensor methods of reading casino tokens may stem from the ability to read a range of values for the reflected light rather than the simply make-break light beam approaches used in some conventional techniques.

Normally, the denomination of a bin of tokens is set by the casino staff or dealer. However, the systems of the disclosure can be easily programmed to a mode in which the color of the casino tokens in a token bin is detected automatically using CIS or LIS sensing, and that color may be used to either set the denomination automatically in the MCU or warn that the stack of casino tokens does not represent the denomination previously set.

Collection of returned data from any sensor method used is a function of the MPU associated with the token tray 102. It is obvious that such data is to be transmitted to a local or remote location such as the data storage unit 153 (FIG. 1) for collection and analysis. This is not unique to electronic systems, and can easily be accomplished via methods such as serial, parallel, Ethernet, fiber optics, or other connections well established in the art. One method granting much utility would be to employ RF transceivers to both send and receive data and control signals. Such operations as setting up denominations, reading bin quantities, and other settings information can easily be passed back and forth from a central computer to the individual tray MPUs. Bluetooth may also be employed as a connection medium for data and command passing. All such methods are well established in the art.

Reporting of token quantities, denomination, bin value, and total tray value can be displayed at each token tray using any of the standard photo-optical methods of information display. Such numeric information can be shown in one table-top display or locations adjacent to the token bins being reported. A displayed visible sum of all monetary values may also be located near the token tray.

While certain illustrative embodiments of the disclosure have been described above, it will be recognized and understood that various modifications can be made to the embodiments and the appended claims are intended to cover all such modifications which may fall within the spirit and scope of the disclosure.

I claim:

1. A casino token counting system, comprising:
at least one microcontroller unit;
at least one token tray comprising:
a plurality of token bins each suitably sized and configured to receive and hold a token stack having one or more casino tokens;
at least one bin slot in each token bin, the bin slot extending the length of the token bin; and
at least one token sensor disposed adjacent to the bin slot and communicably interfacing with the microcontroller unit, the token sensor extending the length of the bin slot and configured to sense intensity of light from the token bin in consecutive units of measurement each corresponding to one pixel; and
the microcontroller unit configured to ascertain whether the casino tokens are present in the token bin and determine a number of the casino tokens in the token bin based on input from the token sensor.

2. The casino token counting system of claim 1 wherein the token sensor is a Contact Image Sensor (CIS) or a Linear Image Sensor (LIS).

3. The casino token counting system of claim 1 wherein the microcontroller unit is configured to utilize a gap counting method of determining whether the casino tokens are present in the token bin and the number of casino tokens in the token stack by detecting token edges or gaps between adjacent casino tokens in the token stack via reading lower-light pixel returns representing the token edges or gaps between properly stacked ones of the casino tokens based on the input from the token sensor.

4. The casino token counting system of claim 1 wherein the microcontroller unit is configured to utilize a stack height counting method of determining whether the casino tokens are present in the token bin and the number of the casino tokens in the token stack by dividing a total pixel height of the token stack by an average thickness of the casino tokens in pixel widths.

5. The casino token counting system of claim 4 wherein the microcontroller unit is configured to recognize at least one gap exceeding a selected size between adjacent ones of the casino tokens in the token stack as improper stacking of the casino tokens in the token stack.

6. The casino token counting system of claim 5 wherein the microcontroller unit is configured to generate a fault or error upon recognizing the gap exceeding the selected size between the adjacent casino tokens in the token stack.

7. The casino token counting system of claim 4 wherein the microcontroller unit is configured to accommodate various thicknesses in the casino tokens for different casino tables or casinos by changing a recorded value of the average thickness of the casino tokens in pixel widths.

8. The casino token counting system of claim 7 wherein the microcontroller unit is configured to store the recorded value of the average thickness of the casino tokens in pixel widths and calibrate or recalibrate the recorded value by measuring a set number of the casino tokens and dividing a pixel height of the token stack by the set number of the casino tokens.

9. The casino token counting system of claim 1 wherein the token sensor is disposed in parallel to each other to obtain redundancy of data for enhanced algorithmic processing of stack height.

10. The casino token counting system of claim 1 wherein the token sensor is disposed at a bottom portion of the token bin.

11. The casino token counting system of claim 1 wherein the token sensor is configured to utilize visible light, infrared light, or ultraviolet light to sense the intensity of the light from the token bin.

12. The casino token counting system of claim 11 wherein the token sensor is configured to utilize ambient light to create shadow conditions on the token sensor to sense the intensity of light from the token bin.

13. The casino token counting system of claim 1 wherein the microcontroller unit is configured to discriminate among the casino tokens on the basis of token color and indicate a denomination error if a color of one or more of the casino tokens differs from a predetermined denominational color for the casino tokens.

14. The casino token counting system of claim 13 wherein the microcontroller unit is configured to modify a computer-maintained monetary denomination of the token bin by discriminating among the casino tokens on the basis of token color.

15. The casino token counting system of claim 14 wherein the microcontroller unit is configured to signal mis-stacking of the casino tokens in the token bin by discriminating among the casino tokens on the basis of token color.

16. The casino token counting system of claim 1 wherein the bin slot comprises a pair of parallel, adjacent bin slots and the token sensor comprises a pair of parallel, adjacent token sensors disposed adjacent to the bin slots, respectively, the token sensors configured to obtain redundancy of data for better algorithmic processing of the height of the token stack.

17. The casino token counting system of claim 1 wherein the microcontroller unit is configured to multiply a detected number of the casino tokens in the token bin by a pre-stored monetary value of the casino tokens for the token bin and add and report a total monetary value of the token bin in the token tray.

18. The casino token counting system of claim 1 wherein the casino tokens are treated with a fluorescent material and the microprocessor is configured to gather token data regarding the casino tokens by returned light reflected from the token bin and received by the token sensor.

19. A casino token counting system, comprising:
at least one microcontroller unit;
at least one token tray comprising:
a plurality of token bins suitably sized and configured to receive and hold a token stack having one or more casino tokens;
at least one bin slot in each token bin, the bin slot extending the length of the token bin; and
at least one token sensor disposed adjacent to the bin slot and communicably interfacing with the microcontroller unit, the token sensor extending the length of the bin slot and configured to sense intensity of light from the token bin in consecutive units of measurement each corresponding to one pixel, the token sensor comprising:
at least one light source configured to emit an incident light beam through the bin slot into the token bin;
at least one converging lens configured to receive a reflected light beam reflected from the token bin; and
at least one photosensor configured to receive a converging light beam from the converging lens;
the microcontroller unit configured to ascertain whether the casino tokens are present in the token bin and determine a number of the casino tokens in the token bin based on input from the token sensor; and
at least one display communicably interfacing with the microcontroller unit via a communication portal comprising at least one of a wired connection and a wireless connection, the display configured to indicate data relating to the number of the casino tokens in the token bin.

20. A casino token counting method, comprising:
obtaining at least one token tray comprising a plurality of token bins suitably sized and configured to receive and hold a token stack having one or more casino tokens;
from adjacent to each token bin, sensing intensity of light from the token bin in consecutive units of measurement each corresponding to one pixel;
ascertaining whether the casino tokens are present in the token bin; and
determining a number of the casino tokens in the token bin if the casino tokens is present in the token bin.
